(19) United States
(12) Patent Application Publication
(10) Pub. No.: US 2007/0130132 A1
(43) Pub. Date: Jun. 7, 2007

(54) Apparatus and method for personalized data delivery

(75) Inventors: Ju Wu, Coquitlam (CA); Mone Siu Man Hsieh, Burnaby (CA)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A. Levallois-Perret (FR)

(21) Appl. No.: 10/882,798

(22) Filed: Jun. 29, 2004

Related U.S. Application Data
(60) Provisional application No. 60/484,203, filed on Jun. 30, 2003.

(51) Int. Cl. G06F 17/30

(52) U.S. Cl. 707/4

(57) ABSTRACT

A computer readable memory stores a set of executable instructions forming a personalized data delivery module. The personalized data delivery module includes executable instructions to receive a data request from a client device, invoke a user profile corresponding to a user generating the data request, gather personalized data from a generic data source using the user profile to select a sub-set of information in the generic data source, and deliver the personalized data to the client device.

### CROSS REFERENCE TO RELATED APPLICATIONS

This application claims the benefit of U.S. Provisional Application Ser. No. 60/484,203, entitled “Apparatus And Method For Personalized Data Delivery,” filed Jun. 30, 2003, the contents of which are hereby incorporated by reference in their entirety.

### BRIEF DESCRIPTION OF THE INVENTION

This invention relates generally to accessing data in a computer network environment. More particularly, this invention relates to a technique for delivering personalized data to a user accessing a computer network environment.

### BACKGROUND OF THE INVENTION

Data can be accessed in a computer network environment using a variety of information management tools. Business Objects Americas, Inc. of San Jose, Calif. sells a variety of information management tools, including Crystal Reports™, Crystal Analysis™, Crystal Enterprise Info™, and Crystal Holos™.

Computer network environments are growing to include wireless devices that provide universal connectivity. Many wireless devices, such as cellular telephones, Personal Digital Assistants (PDAs) and the like are not suited to delivering broad views of information. Instead, these devices are constrained by relatively small displays. Since there is limited display space available, it is important that the information supplied to the display is significant. In addition, since mobile wireless devices tend to have relatively low data reception rates, it is important that they only receive the most relevant data. For example, a scenario where a user has to click through a number of screens on a mobile wireless device is sub-optimal, since it will result in a relatively long delay to obtain the desired information. Mobile wireless devices have limited computation capacity, thus it is desirable to assign data handling tasks to servers that the mobile wireless devices are accessing.

In view of the foregoing, it would be highly desirable to provide a technique for delivering adaptable and customized personalized information to a user of a computer network. While mobile wireless devices advantageously exploit such a technique, it is also beneficially exploited on any client platform since users always desire to receive the most significant information.

### SUMMARY OF THE INVENTION

The invention includes a computer readable memory to store a set of executable instructions forming a personalized data delivery module. The personalized data delivery module includes executable instructions to receive a data request from a client device, invoke a user profile corresponding to a user generating the data request, gather personalized data from a generic data source using the user profile to select a sub-set of information in the generic data source, and deliver the personalized data to the client device.

The invention also includes a computer with a central processing unit and a memory connected to the central processing unit. The memory stores data and executable instructions for processing by the central processing unit. The data includes a plurality of disparate generic data sources. The executable instructions include a personalized data delivery module to (1) invoke a user profile corresponding to a user that generates a data request at a client device, (2) gather personalized data from a selected generic data source of the plurality of disparate generic data sources using the user profile to select a sub-set of information in the selected generic data source, and (3) deliver the personalized data to the client device.

The invention provides rich, relevant information that can be displayed on a mobile device. Server-side data processing tasks limit the amount of computation power required by the mobile device. The personalized data delivery techniques of the invention are advantageously exploited on any platform, not simply mobile devices.

### BRIEF DESCRIPTION OF THE FIGURES

The invention is more fully appreciated in connection with the following detailed description taken in conjunction with the accompanying drawings, in which:

FIG. 1 illustrates a network configured in accordance with an embodiment of the invention.

FIG. 2 illustrates processing operations performed in accordance with an embodiment of the invention.

FIG. 3 illustrates a prior art data drill-through technique.

FIG. 4 illustrates a profile construction graphical user interface that may be used in accordance with an embodiment of the invention.

FIG. 5 illustrates personalized data delivered in accordance with an embodiment of the invention.

FIG. 6 illustrates processing operations performed in accordance with an embodiment of the invention.

FIG. 7 illustrates processing operations associated with an alert module implemented in accordance with an embodiment of the invention.

FIG. 8 illustrates current view data supplied in accordance with an embodiment of the invention.

FIG. 9 illustrates difference view data supplied in accordance with an embodiment of the invention.

Like reference numerals refer to corresponding parts throughout the several views of the drawings.

### DETAILED DESCRIPTION OF THE INVENTION

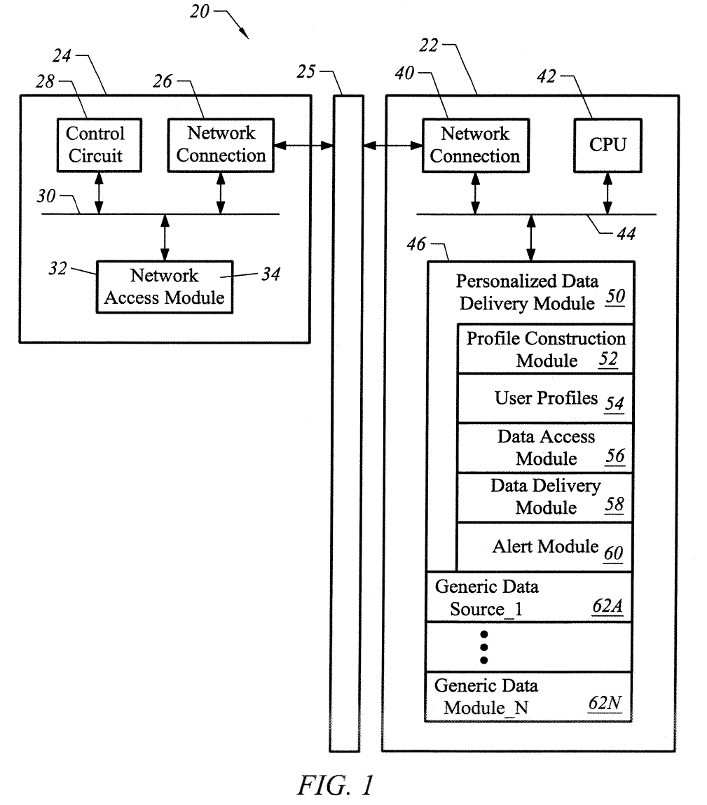

FIG. 1 illustrates a computer network 20 configured in accordance with an embodiment of the invention. The computer network 20 is simplified to illustrate a single server 22 and a single client 24. A transport channel 25, which may be any wired or wireless link, connects the server 22 to the client 24.

The client 24 may be a personal computer with a wired or wireless link. The client 24 may also be a wireless mobile device, such as a personal digital assistant, a cellular telephone, and the like. In a generic implementation, the client 24 has a network connection circuit 26 connected to a control circuit 28 via a bus 30. Also connected to the bus 30 is a memory 32, which stores executable programs, such as a network access module (e.g., a browser) 34.

The server 22 includes a network connection circuit 40 connected to a central processing unit 42 via a bus 44. Also connected to the bus 44 is a memory 46, which stores a set of executable programs, utilized to implement embodiments of the invention. In this embodiment, the memory 46 stores a personalized data delivery module 50, which includes a profile construction module 52 used to produce user profiles 54, which are also stored in the memory 46. The memory 46 also stores a data access module 56, which utilizes one or more user profiles 54 to access selected data, as discussed below. A data delivery module 58 coordinates the delivery of data through the network using known techniques. The memory 46 also stores an alert module 60, which is used to produce customized alerts of personalized data, as discussed below.

The memory 46 also stores one or more generic data sources 62A-62N. A generic data source is a general data source that is not formatted for the delivery of personalized or customized information, instead in represents comprehensive information that must be parsed to obtain personalized or customized information. By way of example, one data source may be a relational database, another data source may be an Online Analytical Processor (OLAP) data source, and another data source maybe a file store.

The configuration of FIG. 1 is exemplary. It should be appreciated that multiple servers may be used to store the generic data sources 62A-62N. Similarly, the personalized data delivery module 50 may be implemented across multiple servers. The invention is typically implemented with multiple clients and multiple servers.

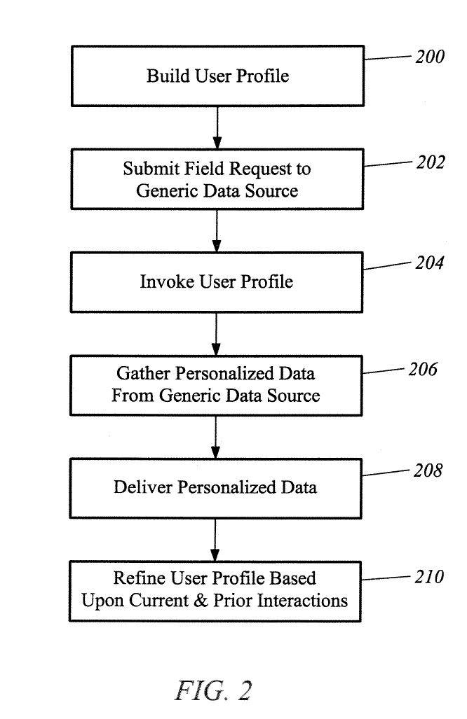

FIG. 2 illustrates processing operations performed in accordance with an embodiment of the invention. Initially, a user profile is constructed (200). The profile construction module 52 includes executable instructions to facilitate this process. As previously indicated, the profile construction module 52 produces user profiles 54.

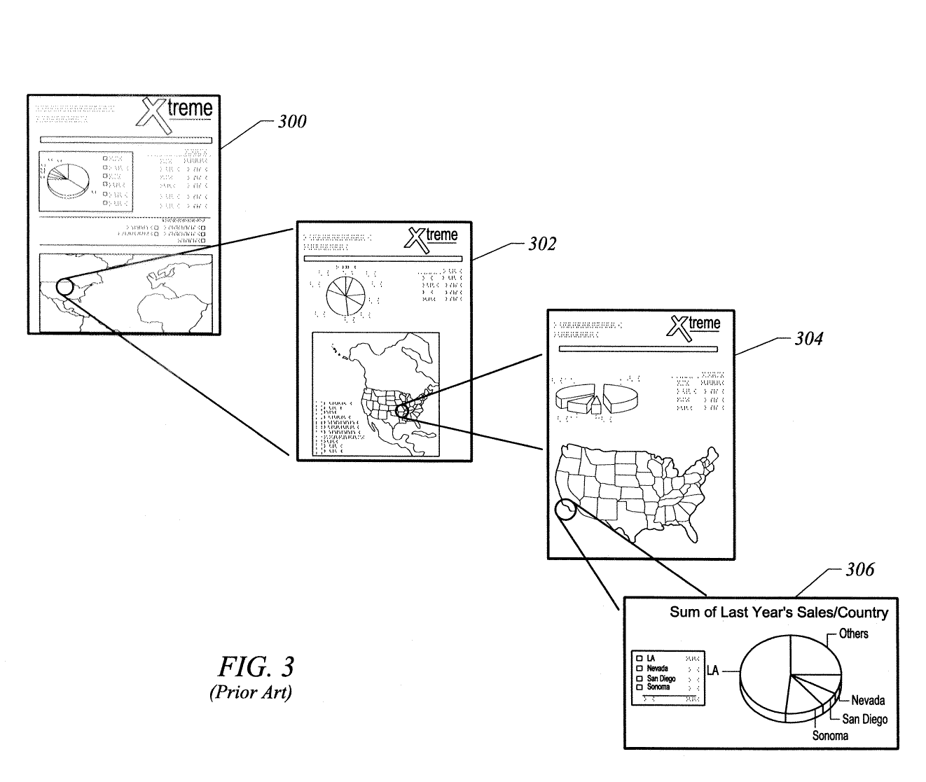

The significance of a user profile is appreciated in connection with an example of a prior art system that does not rely upon a user profile. FIG. 3 illustrates an operation of drilling through a generic data source. For example, assume that corporate headquarters publishes a report that consists of sales data in all international regions, as shown with report 300. In a traditional reporting paradigm, a California sales manager would need to navigate through several reports (e.g., reports 302 and 304) to finally arrive at the data that is pertinent to his personal needs (i.e., California sales data of report 306).

This drill through activity is sub-optimal, particularly in the case of a thin client, such as a mobile wireless device. This sub-optimal scenario is eliminated in accordance with the invention. The profile construction module 50 includes executable code that allows an individual to specify personal or customized data at any level of granularity. Relying upon the example of FIG. 3, a California sales manager can subscribe to a sales channel and specify preferences for California data at any level of granularity.

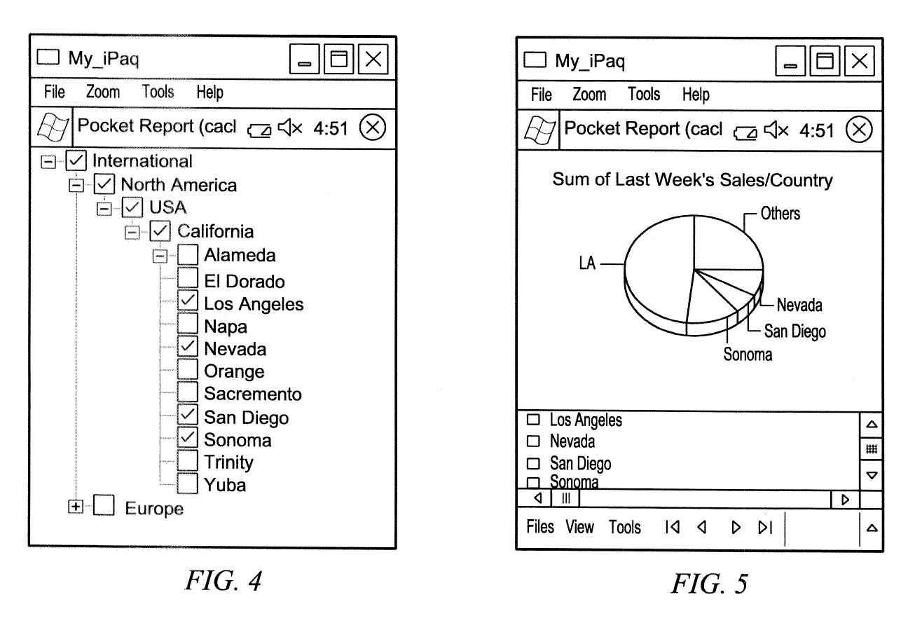

FIG. 4 illustrates a graphical user interface that may be supplied by the profile construction module 52. After the user enters the relevant personalized data, it is stored as a user profile 54. Observe that this technique of the invention allows a sales manager to access information that is tailored to her explicit needs. The technique also frees the information technology department of an organization from having to generate reports for each level of management or for each geographic region.

Returning to FIG. 2, the next operation is to submit a field request to a generic data source (202). The field request is simply a request from a client 24 for generic data 62 stored on a server 22. The personalized data delivery module 50 processes the field request by coordinating the request with the user profile 54 for the individual that generated the request (204). The data access module 56 then selects data from the generic data source 62 in accordance with the information in the user profile 54 (206). The personalized data is then delivered to the user (208).

FIG. 5 illustrates personalized data delivered in accordance with the personalized data specified in FIG. 4. Observe that this report corresponds to the report 306 of FIG. 3. Further note that this report was secured without clicking through a set of reports, as was the case in FIG. 3. Finally, observe that the report content is sufficiently focused so that it can be displayed on a small screen, such as a screen that would be available on a mobile device.

An optional operation of FIG. 2 is to refine a user profile based upon current and prior user interactions (210). The profile construction module 52 preferably includes executable code to intelligently determine the data and information that is most relevant for users based on their behavior patterns. In other words, the profile construction module 52 preferably provides customized detail levels of data that match a user's usage profile. A profile is not limited to a user's personal specifications, such as those defined in FIG. 4. Rather, the profile may include information extrapolated from repeated interactions that the user has with the system. That is, the system's model of the user's profile becomes better defined over time, as the system increasingly improves its ability to match data to the user's needs. For instance, in the California sales manager example of FIG. 4, the system records the manager's preferences for California based data and is intelligent enough to use this information when the user subscribes to other data channels, such as inventory, customer accounts, and the like.

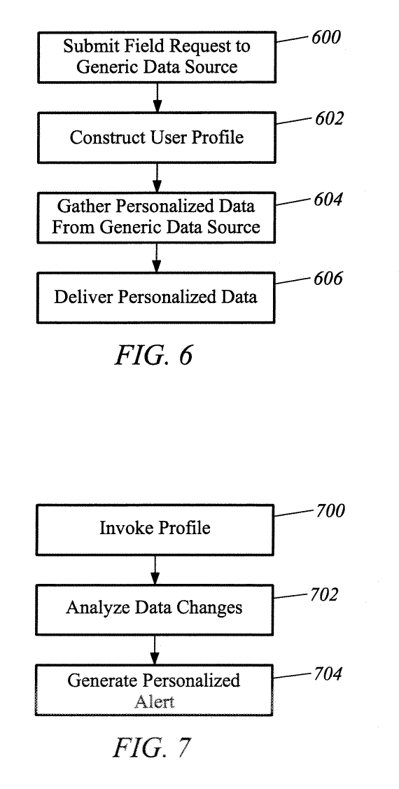

FIG. 6 illustrates alternate processing operations performed in accordance with an embodiment of the invention. The first operation of FIG. 6 is to submit a filed request to a generic data source (600). This represents a user at client device 24 soliciting information from a generic data source 62 stored on a server 22. Next, a user profile is constructed (602). In this example, the user has not explicitly specified preferences in a previous session; therefore the profile construction module 52 generates an appropriate profile based upon amalgamated management profile data. For example, the profile construction module may assign a profile corresponding to an individual with a similar title in the organization. Thus, the profile construction module 52 operates to share and reuse profiles. Similarly, the profile construction module 52 is configured to identify and distribute patterns of best practices so that users can see how others in the organization make the best use of available information. To illustrate the dynamic nature of the profile construction module 52, consider a sales organization that hires a new sales manager to be responsible for four counties in the San Francisco Bay area. To help the new sales manager understand the Bay Area's sales distribution, certain elements from the profiles of each of the top sales persons in each county can be allocated to the new manager's profile, thereby making it possible for him to rapidly acquire a better understanding of the sales metrics within his newly assigned region. Similarly, an organization can choose to distribute profile elements of its top sales person throughout a sales force to help improve efficiencies by sharing rules and best practices.

Returning to FIG. 6, once a user profile is constructed in accordance with the techniques discussed above, personalized data is gathered from a generic data source (604). Thereafter, the personalized data is delivered from the server 22 to the client 24 using standard techniques implemented in the data delivery module 58 (606).

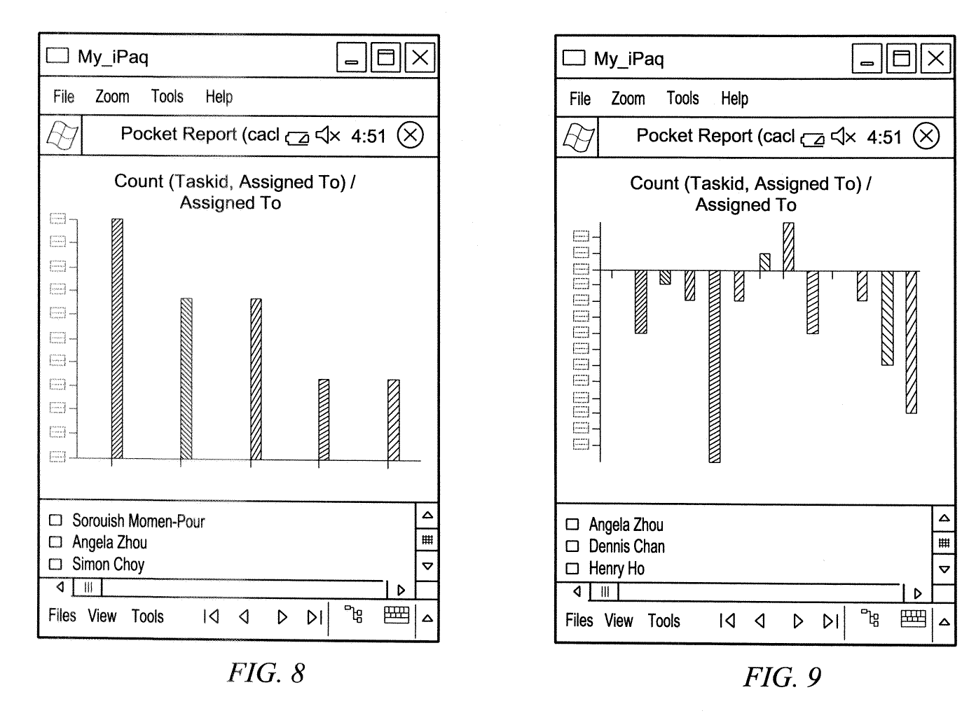

FIG. 7 illustrates alternate processing operations that may be performed in accordance with an embodiment of the invention. As previously indicated, an alert module 60 is stored in memory 46. In one embodiment, the alert module 60 is implemented to perform the operations of FIG. 7. First, the alert module 60 invokes a profile for a user (700). The profile is constructed using the techniques described above. In addition, the profile includes default and/or user-specified rules for analyzing data in a generic data source 62. Based upon the user profile, which specifies data to be tracked, the alert module 60 uses executable code to analyze data changes (702) in a generic data source 62. If significant data changes have occurred, a personalized alert is generated (704). For example, the personalized alert may be in the form of an email message. Observe that the personalized alert is automatically generated in response to a previously established profile. The alert may utilize a variety of formats. For example, the alert may provide a current view of the data, such as shown in FIG. 8. Alternately, the alert may provide a view of the data that highlights differences from a previous view of the data, such as shown in FIG. 9. For example, after returning from a vacation, a purchasing executive can ask the system to show the change in inventory levels since she last checked. Likewise, a developer connecting to a defect tracking system can review the number of defects assigned to her team since her last review. More familiar examples include changes in airline fares or stock price since a previous viewing. The change alert may also provide a trending view of the data.

The personalized alerting feature of the invention is different than prior art techniques that periodically publish alerts based upon absolute data values. Take the example of an inventory-related data store. If a user requests information on, say, North American inventory and gets notified every time the inventory levels drop below a specific threshold, that is customization. If, on the other hand, the personalized data system can alert the user when inventory levels change a specific amount relative to the last time the user viewed the inventory data—that is personalization. Prior art alerting techniques generate an alert when a particular data value hits a defined threshold. However, the alert is defined based on the absolute value of the data. What differentiates this alerting system is that the alert is defined based on changes in the data since the last time a particular user viewed the data. This helps a particular user access data in a very personalized way.

In one embodiment, the invention allows for both online and offline viewing. Users are able to take a snapshot of their data by saving it to a device, and then review it when it is convenient to do so. When reconnecting to the network, the system synchronizes the user's device to display updated information (which can include current views, views that include information pertaining to the change in data since the user's last online view, and trending views). The invention also supports offline profile modifications, in which case the profile is updated on the next synchronization event.

The invention has now been fully described. The following discussion addresses various implementation details associated with embodiments of the invention. The techniques of the invention can be implemented using Crystal Enterprise™, sold by Business Objects Americas, Inc., San Jose, Calif. In such an embodiment, the addition of new data channels parallels the procedure used to add and publish report files to a system. In other words, every report is treated as a personalized data channel. A built-in web service exists to retrieve the report data through a report application server row-set application program interface. Personalized data channels can also be implemented using a web service with defined interfaces to facilitate browsing and data retrieval. For example, UDDI can be used for browsing, XSD can be used for schema fetching, and XML can be used for data fetching.

The following is an example of code that may be used to implement an alert of the invention.

<DataChannelDirectory>

<URI>http://www.crystaldecisions.com/datachannels</URI>
<DataChannel>

<URI>sales.xxp</URI>
<SchemaURI>sales.xxp?schema</SchemaURI>
<InterestedDataSet>

<DataContext>/Canada/BC/Vancouver</DataContext>
<DataContext>/USA/WA/Seattle</DataContext>
<CacheLevel>2</CacheLevel>

</InterestedDataSet>
<Alerting>

<Rule>Sales is dropping (predefined rule)</Rule>
<Rule>Sales of product X is < 4M
(user defined rule)</Rule>
<Schedule>Daily</Schedule>
<Trigger>

<Phone>604-987-6543</Phone>
<Email>salesman@crystaldecisions.com</Email>

</Trigger>

</Alerting>

</DataChannel>

</DataChannelDirectory>

When an alert of this type is implemented in the alert module 60, the alert module 60 checks the alert condition on a scheduled basis. If the condition is met, the notification is sent to the user through a telephone, email, or the like. If the user specifies a difference view, the following operations are performed. First, the system retrieves the latest data based on the user's profile and compares it with the current data to generate a difference data set. The difference data set is then stored on the server 22 and is displayed on the client 24. If the history data includes more than one difference data set, then users can perform a trend analysis. The difference data set reduces the amount of data that needs to be stored. This approach greatly reduces the data explosion problem for duplicate data instances and makes it possible to display difference data very quickly.

The data personalization provided in accordance with the invention takes various forms. First, a personalized data channel can be constructed, for example, as discussed above in connection with FIG. 4. Next, personalized rules, specified by a user and/or default settings, may be used to generate alerts. In the case of a personalized data channel, personalized data is supplied in a synchronous manner in response to a request. In the case of an alert, personalized data is supplied asynchronously as data changes from a previously viewed state.

Those skilled in the art will appreciate that the invention equips decision makers with tools to not only aggregate multiple disparate data services, but to also provide a mechanism to define personalizations on the data. The personalizations allow for data reuse and sharing, and the system seamlessly integrates online and offline viewing modes using synchronization models. Because historical data is stored, users are able to view changes in the data (with the most recently viewed data referenced against current data), and trending reports can be compiled (given enough historical instances). In addition, users are provided with proactive alerting mechanisms that can be used to define rules to discover and trigger alerting, thus helping users acquire insight into the patterns and efficiency of their business processes.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable memory storing a set of executable instructions, comprising:
a personalized data delivery module to
receive a data request from a client device;
invoke a user profile corresponding to a user generating said data request;
gather personalized data from a generic data source using said user profile to select a sub-set of information in said generic data source; and
deliver said personalized data to said client device.

2. The computer readable memory of claim 1 wherein said personalized data delivery module includes executable instructions to generate a graphical user interface to allow a user to specify personal data forming said user profile.

3. The computer readable memory of claim 2 wherein said personalized data delivery module includes executable instructions to refine said user profile based upon actions of said user.

4. The computer readable memory of claim 1 wherein said personalized data delivery module includes executable instructions to generate a user profile for a new user based upon a user profile of a previous user.

5. The computer readable memory of claim 1 wherein said personalized data delivery module includes executable instructions to
invoke said user profile;
analyze, in accordance with said user profile, data changes in said generic data source; and
generate a personalized alert that is delivered to said client device.

6. The computer readable memory of claim 1 wherein said personalized data delivery module includes executable instructions to deliver personalized data to said client device in the form of current view data.

7. The computer readable memory of claim 1 wherein said personalized data delivery module includes executable instructions to deliver personalized data to said client device in the form of difference view data.

8. The computer readable memory of claim 1 wherein said personalized data delivery module includes executable instructions to deliver personalized data to said client device in the form of trend view data.

9. A computer, comprising:
a central processing unit; and
a memory connected to said central processing unit, said memory storing data and executable instructions for processing by said central processing unit, said data including a plurality of disparate generic data sources, said executable instructions including a personalized data delivery module to
invoke a user profile corresponding to a user that generates a data request at a client device,
gather personalized data from a selected generic data source of said plurality of disparate generic data sources using said user profile to select a sub-set of information in said selected generic data source, and
deliver said personalized data to said client device.

10. The computer of claim 9 wherein said personalized data delivery module includes executable instructions to generate a graphical user interface to allow a user to specify personal data forming said user profile.

11. The computer of claim 10 wherein said personalized data delivery module includes executable instructions to refine said user profile based upon actions of said user.

12. The computer of claim 9 wherein said personalized data delivery module includes executable instructions to generate a user profile for a new user based upon a user profile of a previous user with similar responsibilities.

13. The computer of claim 9 wherein said personalized data delivery module includes executable instructions to
invoke said user profile;
analyze, in accordance with said user profile, data changes in said selected generic data source; and
generate a personalized alert that is delivered to said client device.

14. The computer of claim 9 wherein said personalized data delivery module includes executable instructions to deliver personalized data to said client device in the form of current view data.

15. The computer of claim 9 wherein said personalized data delivery module includes executable instructions to deliver personalized data to said client device in the form of difference view data.

16. The computer of claim 9 wherein said personalized data delivery module includes executable instructions to deliver personalized data to said client device in the form of trend view data.
